(19) United States
(12) Patent Application Publication
(10) Pub. No.: US 2009/0003958 A1
(43) Pub. Date: Jan. 1, 2009

(54) Anchor lock tether fitting

(76) Inventors: Knox Howard Thomas, Hebron, KY (US); Leone Thomas H., Burlington, KY (US)

Correspondence Address: EDWARD A SOKOLSKI, 3868 CARSON STREET, 105, TORRANCE, CA, 90503, US

(21) Appl. No.: 11/823,503

(22) Filed: Jun. 27, 2007

(51) Int. Cl. B60P 7/06; B61D 45/00; B64D 9/00

(52) U.S. Cl. 410/105

(57) ABSTRACT

An anchor lock for use in restraining cargo on a land or air transport vehicle is supported on a track mounted on the vehicle, the track having slots formed therein. The device has a center piece forming s lock plate with a bottom portion which matingly fits into one of the slots of the track. The bottom portion of the lock plate is retained in the slot by springs positioned between the lock plate and the side plates which urge the bottom portion of the lock plate against the track. With the bottom portion of the lock plate in the slot, lateral movement of the lock plate along the track is restrained. The top portion of the lock plate has a handle which is used to draw the bottom portion away from the track to facilitate the repositioning of the lock plate along the track. The slotted track has inwardly extending flanges on its opposite sides. A side plate is attached to each of the sides of the lock plate in opposing relationship. The side plates have outwardly extending flanges on their bottoms which matingly engage the flanges formed in the track to restrain the lock plate against lateral movement.

This invention relates to an anchor lock for restraining cargo in an airborne or land vehicle and more particularly to such a device which mounts on a track installed in the vehicle.

### BACKGROUND OF THE PRIOR ART

Anchor locks which fit onto apertured portions of tracks mounted on the walls of land and airborne transportation vehicles are used extensively in the prior art. Such anchor locks are described in U.S. Pat. No. 3,282,229 issued Nov. 1, 1966 to Elsner, U.S. Pat. No. 4,867,623 issued Sep. 19, 1989 to Loyd, and U.S. Pat. No. 3,282,229 issued Nov. 1, 1966 to Elsner.

In all of these prior art patents, the opposite end portions of the locks are fitted into different apertured portions of the track, these end portions being spring actuated to retain them in place. This involves a somewhat more complicated and more expensive structure than that of the present invention which employs a single central spring actuated restraining fitting to prevent the anchor lock from moving longitudinally along the track.

### SUMMARY OF THE INVENTION

A preferred embodiment of the invention includes a center piece forming a lock plate which has a bottom portion which fits into a slot on a slotted track attached to a wall of the vehicle. The top portion of the lock plate has a handle portion for use in lifting the bottom portion of the lock plate out of the slot. A side plate is attached to each of the opposite sides of the center piece. Springs are mounted between the center piece and each of the side plates which urge the center piece downwardly from the side plate. The slotted track has inwardly directed flanges formed on its opposite sides. The side plate has outwardly extending flanges on its opposite sides which matingly fit within the flanges formed on the track. This prevents lateral movement of the anchor lock while the slots in the track prevent longitudinal movement of the anchor lock when it is installed in the track. A hook is slidably attached to the anchor lock to which a strap is attached for use in securing cargo in place.

### DESCRIPTION OF THE DRAWINGS

FIG. 1 is a side view of a preferred embodiment of the invention;

FIG. 2 is an end cross sectional view showing the preferred embodiment attached to the support track;

FIG. 3 is a front cross-sectional view of the preferred embodiment attached to the support track; and

FIG. 4 is top perspective view of the support track employed in the preferred embodiment.

FIG. 5 is an exploded view of the preferred embodiment; and

FIG. 6 is a top perspective view of the support track employed in the preferred embodiment.

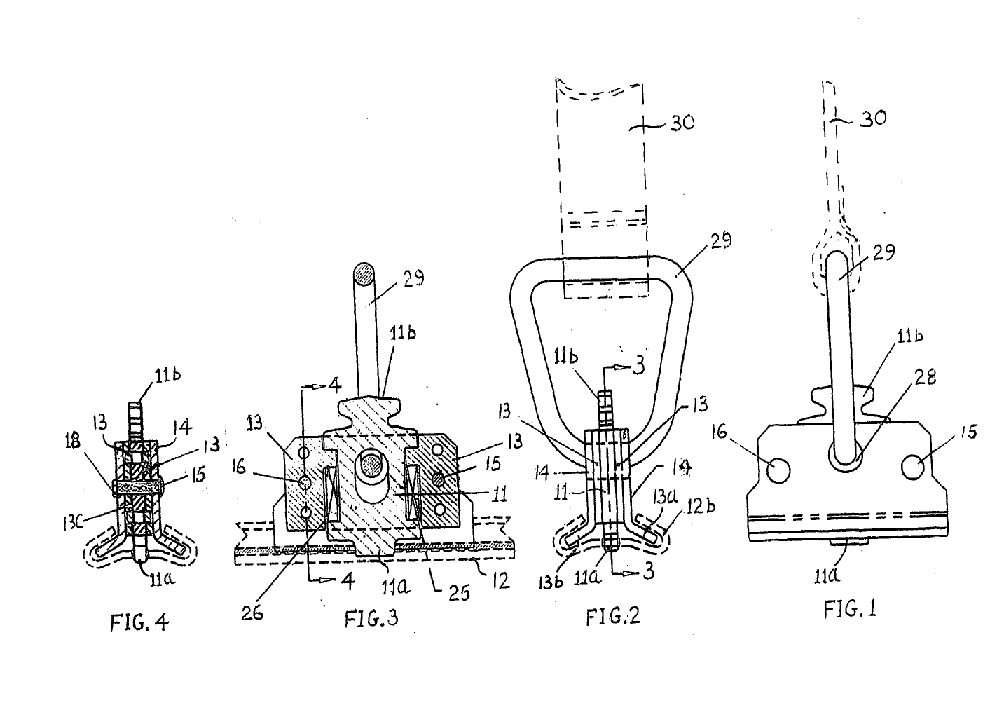

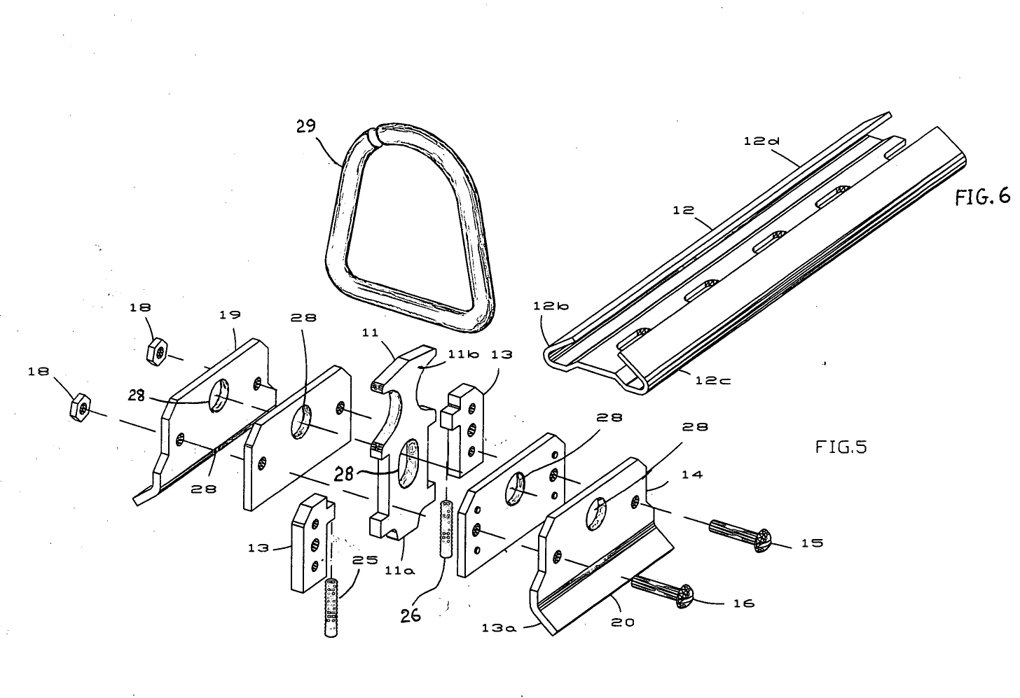

### DESCRIPTION OF THE PREFERRED EMBODIMENT

Referring to the Figures, a preferred embodiment of the invention is illustrated. Center piece 11 piece forms a lock plate having a bottom portion 11a which fits into any one of the slots 12a of track 12 in mating engagement. Track 12 is mounted on either one of the side walls or the ceiling or floor of a transportation compartment of a vehicle. Track 12 has inwardly directed flanges 12b and 12c. The top portion 11b of the lock plate 11 is in the form of a handle for lifting bottom portion 11a out of a slot 12a in which it is installed and installing it in another slot.

A pair of similar side plates 13 and 14 are attached to the opposite sides of lock plate 11 by means of bolts 15 and 16 and nuts 18. The side plates are prevented from sliding relative to the lock plate by means of knobs 19 on the side plates which fit into apertures 20 on the lock plate. Springs 25 and 26 are mounted between the lock plate 11 and the side plates which urge the lock plate downwardly from the side plates into abutment against the bottom of track Each of the side plates has an outwardly extending flanges 13a and 14a which are fitted within the flanges 12b and 12c of the track. The flanges prevent lateral movement of the anchor lock while the slots in the track prevent prevent longitudinal movement of the anchor lock when it is installed in the track. An attachment member 29 is connected to the anchor lock and side hooks through an aperture 28 formed through both the anchor lock and side hooks. A strap 30 for attachment to the cargo to be restrained is attached to member 29.

While the invention has been described and illustrated in detail, this is intended by way of illustration and example only and not be way of limitation, the coverage of this patent be limited by the terms of the following claims:

I claim:

1. An anchor lock for use in restraining cargo in a transportation compartment of a vehicle, an attachment member being connected to said anchor lock and a strap connected between the attachment member and the cargo, said vehicle having a slotted track attached to one of the sides, floor, or ceiling of said compartment comprising:
a center piece forming a lock plate, said lock plate having a bottom portion fitted into one of said slots of said slotted track, said lock plate having a top portion forming a handle for use in drawing said bottom portion out of said track;
first and second side plates each being attached to one of the sides of said center piece in opposing relationship to each other, and
means for resiliently urging said lock plate into said one of said track slots;

2. The anchor lock of claim 1 wherein said means for resiliently urging said lock plate into said one of said track slots comprises a spring connected between, each of said side plates and said lock plate.

3. The anchor lock of claim 1 wherein said lock plate has a top portion forming a handle for use in drawing said bottom portion of the lock plate out of said one of said slots.

4. The anchor lot of claim 1 wherein said lock plate has a top portion forming a handle for use in drawing said bottom portion of said lock plate out of said one of said slots of the slotted track.

5. The anchor lock of claim 1 and further including means for joining said side plates and said lock plate together in firm attachment to each other.

6. The anchor lock of claim 5 wherein said means for joining said side plates and said lock plate together comprises bolts with screws attached to said bolts,, said side plates and said lock plate having apertures formed therein through which said bolts are fitted.

7. An anchor lock for use in restraining cargo in a transportation compartment of a vehicle, said vehicle having a track attached to a side, floor or ceiling of said compartment, said track having slots formed therein, an attachment member connected to the anchor lock and a strap attached between the attachment member and the cargo, said anchor lock comprising:
a center piece forming a lock plate having a bottom portion fitted into one of said slots and a top portion forming a handle for use in drawing said bottom portion out of said one of said slots;
first and second spacer plates, each having knobs formed thereon, apertures being formed in said lock plate into which said knobs matingly fit;
a separate spring installed between said lock plate on each and each of said side plates,said springs urging said side plates away from said lock plate and against said track; and
nuts attached to the ends of said bolts, said spacer plates and said lock plate having apertures formed therein through which said bolts are fitted to retain said side plates and said lock plate firmly together.
